(19) United States
(12) Patent Application Publication
(10) Pub. No.: US 2011/0286102 A1
(43) Pub. Date: Nov. 24, 2011

(54) Optical Adaptor

(75) Inventor: Mark Jeffs, Denbighshire (GB)

(73) Assignee: QIOPTIQ LIMITED, Denbighshire (UK)

(21) Appl. No.: 13/144,273

(22) PCT Filed: Feb. 10, 2010
(86) PCT No.: PCT/GB2010/000245

§ 371 Date: Jul. 12, 2011

(30) Foreign Application Priority Data
Feb. 16, 2009 (GB) 0902571.9

(51) Int. Cl. G02B 9/10

(52) U.S. Cl. 359/648

(57) ABSTRACT

An optical adaptor is disclosed for use in combination with an optical imaging system. The adaptor is specifically configured so that when it is positioned within the optical path between an object and the imaging system, the adaptor corrects the field curvature of the imaging system so as to produce a substantially flat image of a curved object. The adaptor comprises a primary lens unit of positive power which in use is towards the object and which preferably takes the form of a thick meniscus lens having an overcorrect Petzval Sum, and a secondary lens unit of negative power which in use is towards the imaging system and which preferably takes the form of a relatively thin meniscus lens.

### BACKGROUND OF THE INVENTION

The present invention relates to an optical adaptor, and more particularly relates to an optical adaptor suitable for use in combination with an optical imaging system so as to correct the field curvature of the imaging system when viewing a curved object so as to produce a substantially flat image of the curved object.

The optical adaptor of the present invention has been developed for use with an optical viewing system of the type generally used for viewing and analysing cell cultures, and the invention is therefore described herein with specific reference to such systems. However, it should be appreciated that the invention may find use in other applications where it is desired to adjust the field curvature of a base imaging system in a manner effective to allow the imaging system to produce a focussed image of a curved object in a substantially flat image plane.

### DESCRIPTION OF THE PRIOR ART

Sample viewing devices have been proposed previously for use in viewing and analysing cell cultures. Modern techniques of cell line development, cellular research and drug discovery typically involve the need to view and analyse a very large number of different cell cultures. The use of microplates (or well-plates as they are sometimes known) has therefore now become common. A microplate is typically moulded from plastics material and comprises a plurality of individual wells arranged in an array. Different culture samples may thus be inserted in each well, and the microplate inserted into a viewing/analysing machine configured to view the samples located in the individual wells and analyse the results. Such analysis can typically involve the use of specialist software to measure confluence and cell growth, and typically includes software specially configured to count cell colonies.

As will be appreciated, it is important that such sample viewing devices provide high quality images of the various samples located in a microplate. The sample viewing devices thus comprise precise optical imaging systems which are configured to produce focussed images of the samples lying in each well of the microplate, the images typically being formed on a flat sensor such as a CCD sensor or a CMOS sensor. This is relatively easy to achieve when the microplates being viewed have flat-bottomed wells, because the optical imaging system can easily be configured to produce flat images of substantially flat objects (effectively the flat bottoms of each well). However, problems arise when microplates having wells with curved (and typically outwardly convex) bottoms are used, because the imaging system is then required to image a curved object, resulting in a curved image formation plane, thereby preventing the system from producing a well focussed image on the flat sensor. There is therefore a need for some convenient way of adjusting the field curvature of such imaging systems.

### SUMMARY OF THE INVENTION

It is therefore an object of the present invention to provide an optical adaptor suitable for use in combination with an optical imaging system.

It is another object of the present invention to provide an improved sample viewing device.

Accordingly, a first aspect of the present invention provides an optical adaptor for use in combination with an optical imaging system, the adaptor being configured, when positioned between an object and the imaging system, to correct the field curvature of the imaging system so as to produce a substantially flat image of a curved object, the adaptor comprising: a primary lens unit of positive power which in use is towards the object, and a secondary lens unit of negative power which in use is towards the imaging system, the primary lens unit having an overcorrect Petzval Sum.

Preferably, said primary lens unit comprises a primary meniscus lens.

The primary meniscus lens may be configured such that its concave surface faces said object in use and has a smaller radius of curvature than its convex surface.

Preferably, the optical adaptor is configured such that 2≦R_{V}/R_{C}≦6, where R_{V} denotes the radius of curvature of the convex surface of the primary meniscus lens, and R_{C} denotes the radius of curvature of the concave surface of the primary meniscus lens. Most preferably, R_{V}/R_{C} is approximately equal to 3.

The optical adaptor is preferably configured such that 3≦T/R_{C}≦7, where T denotes the thickness of said primary meniscus lens and R_{C} denotes the radius of curvature of the concave surface of the primary meniscus lens. Most preferably, T/R_{C} is approximately equal to 4.5.

Conveniently, the optical adaptor is configured for use in imaging an object having a curved surface which is substantially convex towards the adaptor, wherein R_{O}≦R_{V}≦2.5 R_{O}, where R_{O} denotes the radius of curvature of said convex object surface, and R_{V} denotes the radius of curvature of the convex surface of the primary meniscus lens.

The primary lens unit may comprise a compound lens.

The primary lens unit may comprise a doublet lens.

The secondary lens unit preferably comprises a secondary meniscus lens.

The secondary meniscus lens is preferably configured such that its concave surface faces said primary lens unit and has a smaller radius of curvature than its convex surface.

The secondary lens unit may comprise a compound lens.

The secondary lens unit may comprise a doublet lens.

Preferably, the thickness of said primary lens unit is substantially greater than the thickness of said secondary lens unit. Particular embodiments are proposed in which the thickness of said secondary lens unit is approximately 40% of the thickness of said primary lens unit.

The optical adaptor of the present invention may be provided in combination with said optical imaging system. Preferably, said optical imaging system is configured to have an f-number of at least 4.

According to another aspect of the present invention, there is provided a sample viewing device comprising an optical adaptor of the type defined above, and optical imaging system, the viewing device further comprising means to support a substantially transparent sample carrier (such as a microplate) in a viewing position in which at least part of the sample carrier may be imaged by said imaging system, and wherein said optical adaptor is selectively positionable in the optical path between said sample carrier and the imaging system. The optical adaptor can thus be removed from the optical path between the sample carrier and the imaging system when the sample carrier takes the form of a microplate with flat-bottomed wells, so that the imaging system can image samples within the individual wells in a conventional manner. However, by inserting the optical adaptor of the present invention in the optical path between the sample carrier and the imaging system, the viewer can be re-configured to provide clearly focussed images of samples within the individual wells of a curved-well microplate.

### BRIEF DESCRIPTION OF THE DRAWINGS

So that the invention may be more readily understood, and so that further features thereof may be appreciated, embodiments of the invention will now be described by way of example with reference to the accompanying drawings in which:

FIG. 1 shows, in perspective view, a sample viewing device in combination with a display;

FIG. 2 is a schematic illustration showing a base optical imaging system provided within the viewing device of FIG. 2, in combination with a microplate;

FIG. 3 is a ray diagram, showing the base optical imaging system of FIG. 2 producing an image of the bottom of a curved well;

FIG. 4 is a ray diagram illustrating an optical adaptor in accordance with the present invention provided in the optical path between the curved well and the base optical imaging system;

FIG. 5 illustrates an exemplary optical adaptor in combination with a base optical imaging system; and

FIG. 6 is a graph showing paraxial astigmatic curves as a function of image height for the system illustrated in FIG. 5.

### DETAILED DESCRIPTION OF THE PREFERRED EMBODIMENTS

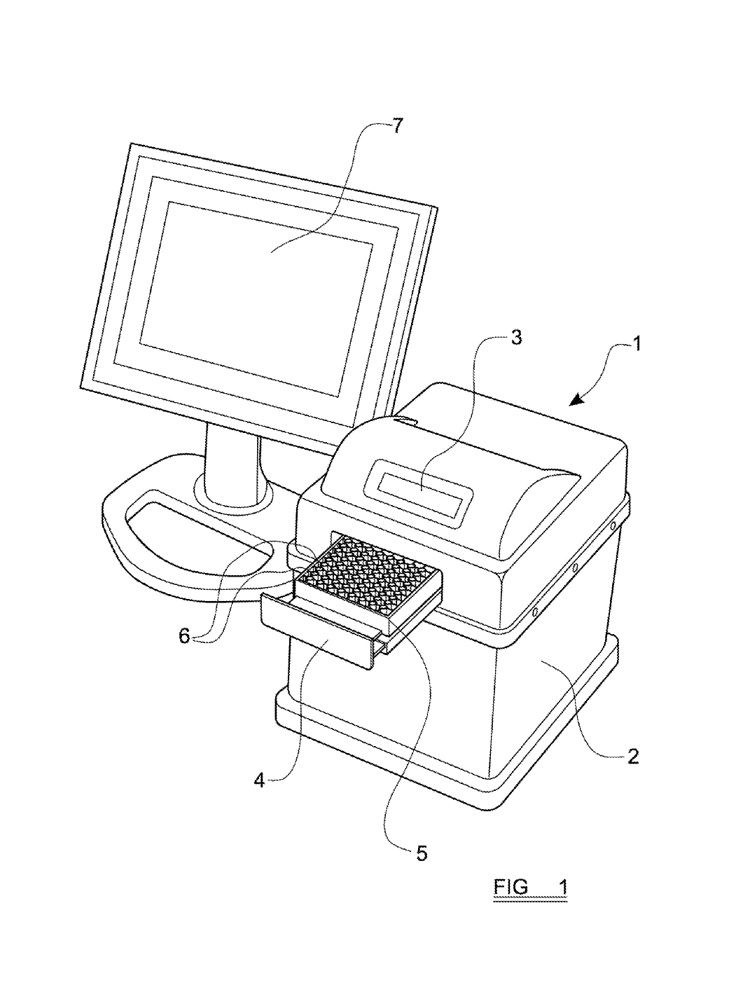

Referring in particular to FIG. 1, there is illustrated a sample viewing device 1. The viewing device comprises an external housing 2 and has a display 3, such as an LCD display, in order to display data in connection with the operational status of the device. In the upper part of the housing 2, is provided a moveable tray 4 which serves as a support for a microplate 5. The tray 4 is selectively moveable between a loading position illustrated generally in FIG. 1 and a viewing position. In the loading position illustrated, the tray is conveniently presented for the insertion of the microplate 5. When the microplate has been placed on the supporting tray 4, the tray is then moved to the viewing position by retraction into the housing 2. The tray 4 is preferably moved between its loading and viewing positions by a motor-drive mechanism provided within the housing 2 and controlled either by one or more buttons provided on the device 1 itself, or alternatively may be controlled by a computer operatively connected to the device 1.

The microplate 5 is of generally conventional form and comprises a plurality of individual wells 6 arranged in a close-packed array, each well being presented to receive a respective sample for analysis by the device.

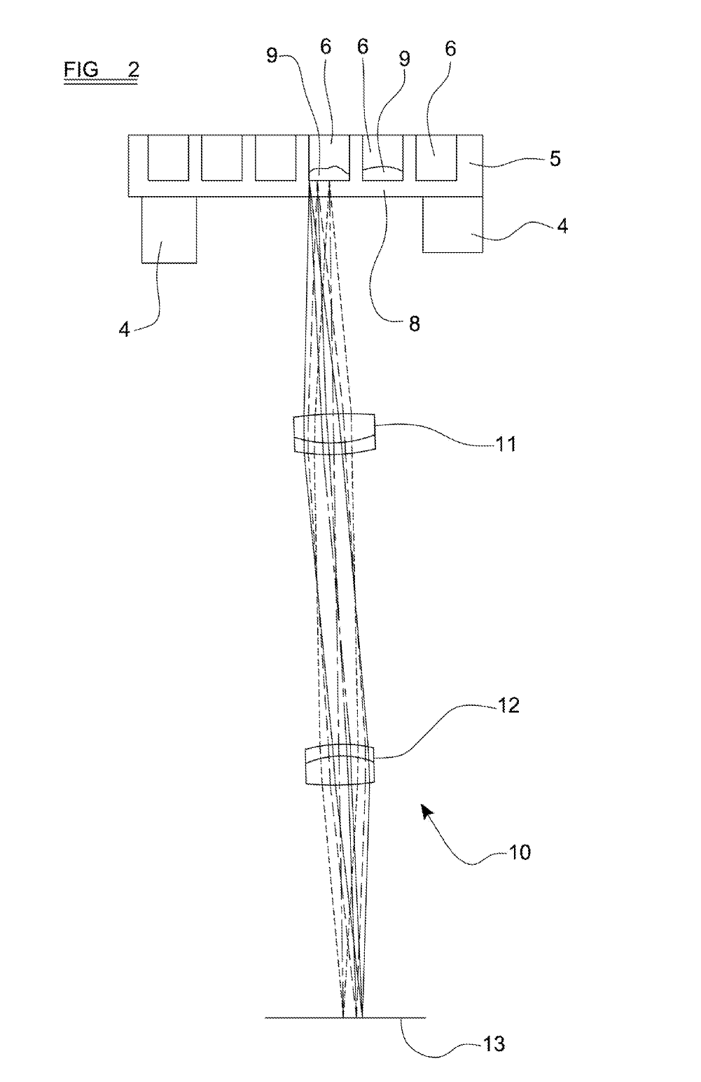

FIG. 1 illustrates the sample viewing device 1 in combination with a computer display monitor 7, which is used to display images of the well contents obtained via an optical imaging system provided within the housing 2 and which is illustrated in more detail in FIG. 2.

So, turning now to consider FIG. 2 in more detail, it will be noted that the microplate 5, which is supported in the viewing position of the moveable tray 4, is shown as having a configuration in which each of the individual wells 6 has a substantially flat bottom 8. It should also be appreciated that the microplate 5 or at least the respective flat bottoms 8, is substantially transparent so that respective samples 9 placed within the wells 6 can be viewed from beneath the microplate 5. It will therefore be noted that the optical imaging system of the viewing device, indicated generally at 10, is provided beneath the microplate 5. The optical imaging system 10 is generally conventional and may, for example, comprise a pair of spaced-apart doublet lenses 11, 12 as illustrated in FIG. 2. It is to be noted that the optical imaging system 10 is configured to form an image of the sample 9 sitting within the well 6, when the well 6 is aligned with the optical axis of the imaging system 10. In practice, the optical imaging system 10 is arranged so as to be moveable within the housing of the viewing device and in particular is configured to scan across the microplate 5 so as to take respective images of each occupied well 6.

As illustrated in FIG. 2, the optical imaging system 10 is arranged so as to form a focused image of the sample 9, the image being formed in a substantially flat image plane, as defined by the surface of a substantially flat image sensor 13, such as a CCD sensor or a CMOS sensor.

As indicated above, the optical imaging system 10 is illustrated in FIG. 2 in combination with a microplate 5 having wells 6 with substantially flat bottoms 8. The samples 9 are typically provided in solution and hence closely conform to the flat surface of the well-bottom. The optical imaging system 10 is thus configured to provide a substantially flat image of a substantially flat object, as defined by the flat surface to which the sample 9 conforms. Whilst the imaging system 10 will perform well when used in combination with flat-bottomed microplates 5, reliably creating substantially flat images on the sensor 13, problems can arise when the flat-bottomed microplate 5 is replaced with a microplate whose wells have curved bottoms. Such microplates are in common use in laboratories and typically comprise a closely packed array of wells, each having a rounded bottom which presents a convex surface to the optical imaging system 10 when the microplate is loaded into the viewing device 1.

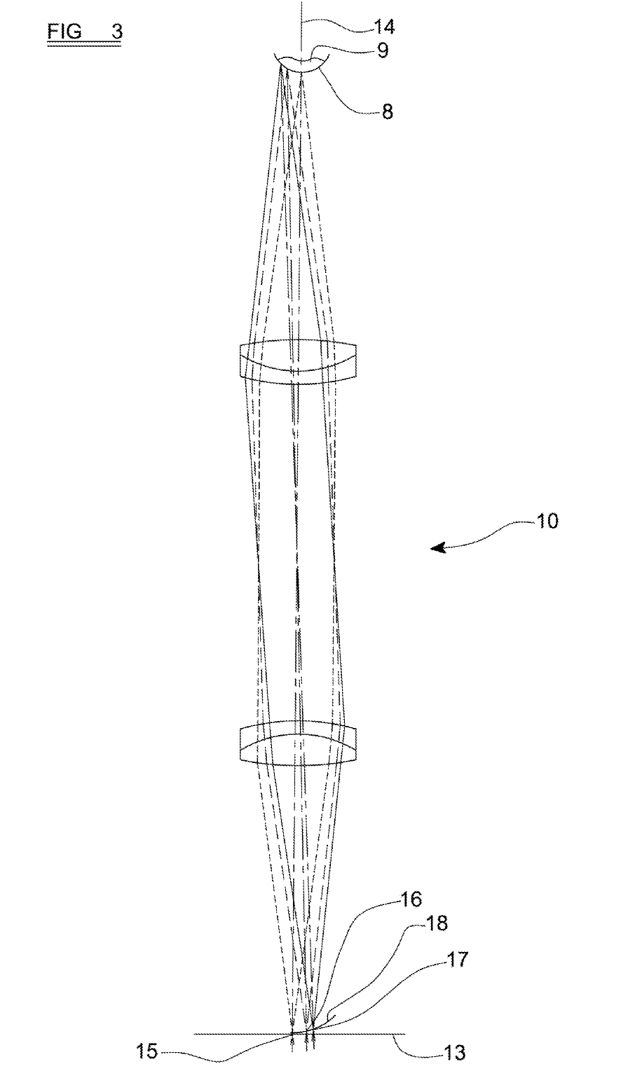

FIG. 3 illustrates, in the form of a ray diagram, the unmodified imaging system 10 when used to produce an image of a sample 9 sitting within a well having a curved bottom 8, the bottom surface of the well being convex towards the imaging system. FIG. 2 illustrates representative light rays focused on the object, as defined by the curved surface 8, and which propagate through the imaging system 10 towards the substantially flat image plane of the sensor 13.

As illustrated in FIG. 3, the rays denoted by the short dashed lines, which are focused on a point on the object surface 8 which coincides with the optical axis 14 of the arrangement, propagate through the imaging system and focus at a point 15 which lies in the plane of the image sensor 13. Thus, the optical imaging system 10 forms a well focused image of the central region of the curved object 8 on the planar image sensor 13. However, the off-axis rays, focused on the curved object surface 8 at positions spaced from the optical axis 14, as denoted by the solid lines and by the long-dashed lines in FIG. 3, are not focused by the imaging system 10 at points located in the plane of the image sensor 13, but rather are focused at points indicated at 16 and 17, which lie in front of the plane of the image sensor 13. The uncorrected imaging system 10 thus forms a curved image 18 as denoted by the curved line intersecting the aforementioned focused points 15, 16 and 17, which means that the actual image formed on the planar image sensor 13, whilst being generally well-focused in its central region, is blurred at its edges. For purposes of accurately analysing the sample 9, such a blurred image is unacceptable.

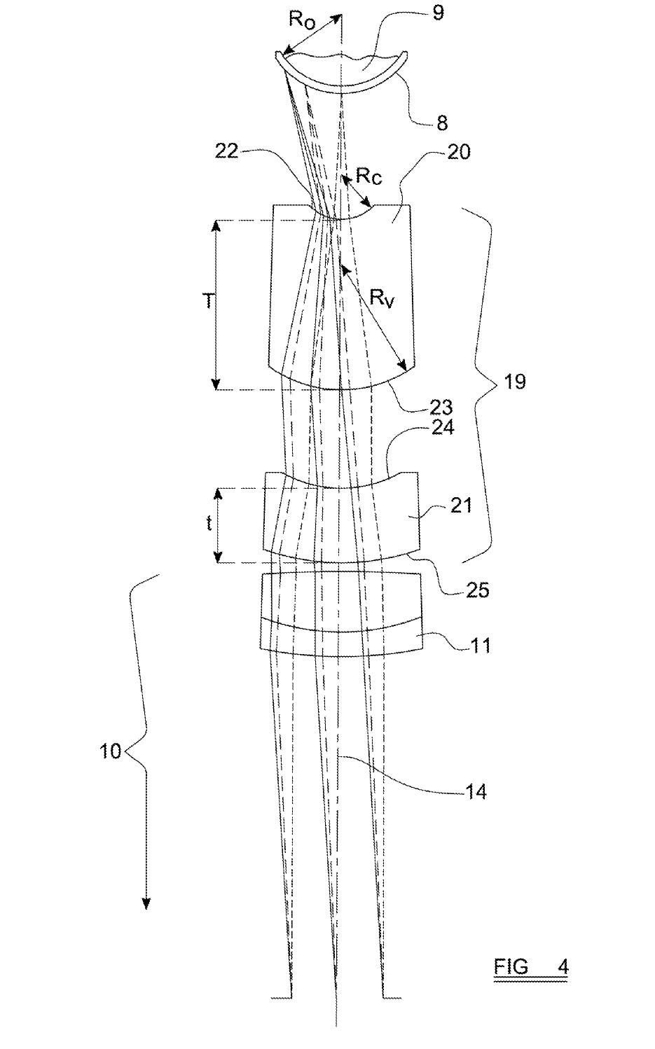

Turning now to consider FIG. 4, there is illustrated an optical adapter 19 in accordance with the present invention, the optical adapter 19 being illustrated in an operative position in which it lies within the optical path extending between the curved object 8 as defined by the curved well bottom, and the first lens 11 of the base optical imaging system 10. As will be seen, the optical adapter comprises two discrete lens units, namely a primary lens unit 20 and a secondary lens unit 21, the two lens units being spaced from one another along the optical axis 14 of the arrangement. It should be appreciated that although FIG. 4, for the sake of clarity, does not illustrate the entire base imaging system 10 and the image sensor 13, the base imaging system 10 remains substantially unchanged.

As will be explained below, the optical adapter 19 of the present invention serves to modify the field curvature of the base imaging system 10 so that the combination of the optical adapter 19 and the base imaging system 10 will produce a substantially flat focused image on the image sensor 13, rather than a curved image as illustrated in FIG. 3. The optical adapter 19 thus effectively adapts the base imaging system for use in providing high quality images of samples held in curved wells. In order to maximise the versatility of the sample viewing device, it is therefore proposed that the optical adapter 19 may be moveable within the housing of the imaging device so as to be selectively positionable in the optical path between the microplate and the optical imaging system 10. Thus, when the optical adapter 19 is positioned in the optical path between the curved object 8 and the imaging system 10, as illustrated in FIG. 4, the viewing device 1 becomes configured for use with microplates having curved wells, whereas when the optical adapter is removed from the optical path between the microplate and the imaging system, the viewing device becomes configured for use with flat-bottomed microplates.

The primary lens unit 20 takes the form of a meniscus lens having very significant thickness T as measured along the optical axis 14. As will be seen, the concave surface 22 of the meniscus lens 20 is arranged in use to face the object (i.e. the base 8 of the well being viewed). The meniscus lens 20 is furthermore configured such that the concave surface 22 has a more steeply curved surface than the oppositely directed convex surface 23 of the lens. In the preferred arrangement, this relationship between the two surfaces 22, 23 of the lens 20 can be expressed as 2.0≦R_{V}/R_{C}≦6.0, where R_{V} denotes the radius of curvature of the convex surface 23, and R_{C} denotes the radius of curvature of the concave surface 22. Most preferably, R_{V}/R_{C} is approximately equal to 3.0.

As will be appreciated, conventional meniscus lenses having a more steeply curved concaves surface than convex surfaces are considered to be negative lenses, in the sense that they are diverging. However, the primary meniscus lens 20 of the adaptor 19 is specifically configured, on account of its very significant thickness T, to be converging, and hence has positive power. This converging nature of the lens 20 is clearly illustrated in FIG. 4, as exemplified by the axial bundle of rays (denoted by the short-dashed lines) converging as they pass through the lens. The thickness T of the primary lens 20 can be expressed in relation to the radius of curvature R_{C} of the concave surface 22 by the expression 3.0≦T/R_{C}≦7.0, whilst the ratio T/R_{C} is most preferably approximately equal to 4.5.

The significant thickness T of the primary meniscus lens 20, as expressed above, allows the lens to have positive (converging) power, whilst simultaneously having the field curvature properties of a negative lens. The lens 20 thus has a strong component of positive Petzval sum, and so has an overcorrect Petzval sum.

It will this be seen that the primary meniscus lens 20 serves to converge the rays passing through it from the curved object 8.

The secondary lens unit 21 serves to correct the power of the primary lens 20 in order for the optical adaptor to interface accurately with the first lens 11 of the base imaging system 10. As illustrated in FIG. 4, the secondary lens unit 21 comprises a second meniscus lens, arranged with its concave surface 24 facing towards the primary lens 20, and its convex surface 25 facing the first lens 11 of the base imaging system.

In contrast to the primary lens 20, the secondary meniscus lens 21 has a more conventional configuration, and hence is negative (diverging), as characterised by the fact that its concave surface 24 is more steeply curved than its convex surface 25. The secondary lens 21 serves to adjust the overall power of the adaptor 19 so that it cooperates appropriately with the first lens 11 of the base imaging system.

Whilst the thickness t of the secondary lens 21, as measured along the optical axis 14 is not as significant to the operation of the adaptor as the thickness T of the primary lens 20, it has been found that the best results are achieved when the thickness t of the secondary lens is approximately 40% of the thickness T of the primary lens.

The primary meniscus lens 20 is preferably made from either crown glass, lanthanum crown glass, or a lanthanum flint glass, whilst the secondary meniscus lens 21 is preferably made from a more dispersive material such as flint glass, thereby configuring the secondary meniscus lens such that it corrects the longitudinal and lateral colour aberrations of the primary meniscus lens 20.

The magnitude of the various parameters given above are intended to describe the configuration of an optical adaptor suitable for use with a base imaging system having an effective f-number of 4 or higher (i.e. “slower”), whilst the base system itself has principal rays less than 10 degrees from telecentric. Most preferably, the principal rays of the base system converge by 1.5 degrees from the full field of the object 8 towards the base imaging system 10, and the optical adaptor of the preferred embodiment is effective to modify the field curvature of the overall system sufficiently to produce a substantially flat image of the curved object 8.

As will be understood by those of skill in the art, the optical adaptor of the present invention and the base imaging system are optimised for effective use with one another. In particular, the exact curvatures and glass-types of the primary meniscus lens 20 and the secondary meniscus lens 21 will be selected to provide a balanced correction of the remaining third- and higher-order aberrations in conjunction with the base imaging system 10.

It should be appreciated that although the invention has been described above with specific reference to an embodiment in which the primary and secondary lens units 20, 21 comprise single meniscus lenses, in variants of the invention it is envisaged that either or both of the lenses could be replaced by compound lenses, such as doublet lenses. It is envisaged that in the event that a doublet lens is used, it could take the form of a cemented doublet comprising elements of two different glass types. Lenses of this type could be used to adjust the optical aperture (i.e. the f-number) of the base system, or extend its field of view.

### Example

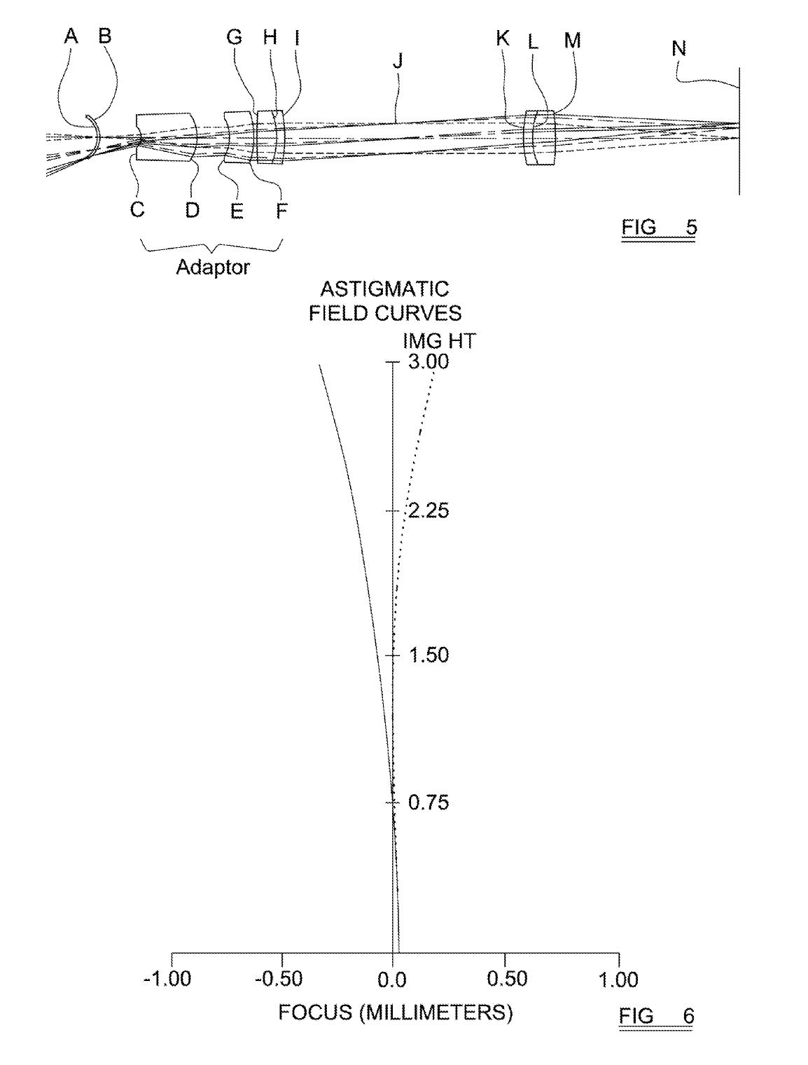

An example of a specific optical adaptor in accordance with the present invention and a base optical system is illustrated in FIG. 5 and is defined by the data set out in Table 1 below, where the optical adaptor corrects for an object having a radius of 5 mm, and where:

Surface=the lens surfaces A to N indicated in FIG. 5

R=the radii of curvature of respective lens surfaces

T=the axial thickness of the following lens material or air

Nd=the refractive index of the lens material referenced to a wavelength of 587.6 nm

Vd=the Abbe number of the lens material referenced to a wavelength of 587.6 nm

As will be appreciated, therefore, the object being viewed is located against the inside surface (i.e surface A) of a curved well of a microplate sample holder. The base optical system is a 1:1 relay and represented by surfaces G to M in Table 1 and FIG. 5, whilst the optical adaptor of the present invention is represented by surfaces C to F.

Furthermore, in the specific example defined, Magnification=−0.789, FNo at image=6.25, and Object size=±3 mm

TABLE 1

| Surface | R | T | Nd | Vd |
|---|---|---|---|---|
| A = OBJECT | −5.00000 | 0.5000 | 1.4875 | 70.4 |
| B | −5.50000 | 9.5000 | | |
| C | −2.75000 | 12.4381 | 1.7130 | 53.8 |
| D | −8.08000 | 7.3489 | | |
| E | −8.30000 | 5.5038 | 1.7551 | 27.6 |
| F | −14.70000 | 0.7000 | | |
| G | 73.48200 | 4.5000 | 1.6177 | 49.8 |
| H | −14.65000 | 1.8000 | 1.8052 | 25.4 |
| I | −28.74320 | 25.3000 | | |
| J = STOP | 24.7363 | | | |
| INFINITY | | | | |
| K | 28.74320 | 1.8000 | 1.8052 | 25.4 |
| L | 14.65000 | 4.5000 | 1.6177 | 49.8 |
| M | −73.48200 | 39.7200 | | |
| N = IMAGE | | | | |
| INFINITY | | | | |

FIG. 6 represents a plot showing paraxial astigmatic curves for the example system as a function of image height, and thus illustrate the optical correction onto a flat image. The solid line represents the Radial focus curve and shows the longitudinal focus position for a bundle of rays taken across the Stop J in an axis orthogonal to the plane of the page and thus extending out of the page. The dotted line represents the Tangential focus curve and shows the focus position for a bundle of rays defined in the plane of the page, at the Stop J. As will be appreciated, the foci for rays in these two orthogonal planes are not coincident, and their relative positions vary as a function of the image height.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. An optical adaptor for use in combination with an optical imaging system, the adaptor being configured, when positioned between an object and the imaging system, to correct the field curvature of the imaging system so as to produce a substantially flat image of a curved object, the adaptor comprising: a primary lens unit of positive power which in use is towards the object, and a secondary lens unit of negative power which in use is towards the imaging system, the primary lens unit having the field curvature properties of a negative lens and comprising a primary meniscus lens configured such that its concave surface faces said object in use and has a smaller radius of curvature than its convex surface, the adaptor being configured for use in imaging an object having a curved surface which is substantially convex towards the adaptor, wherein R_{O}≦R_{V}≦2.5 R_{O}, where R_{O} denotes the radius of curvature of said convex object surface, and R_{V} denotes the radius of curvature of the convex surface of the primary meniscus lens.

2. An optical adaptor according to claim 1, wherein 2≦R_{V}/R_{C}≦6, where R_{C} denotes the radius of curvature of the concave surface of the primary meniscus lens.

3. An optical adaptor according to claim 2, wherein R_{V}/R_{C} is approximately equal to 3.

4. An optical adaptor according to claim 1, wherein 3≦T/R_{C}≦7, where T denotes the thickness of said primary meniscus lens and R_{C} denotes the radius of curvature of the concave surface of the primary meniscus lens.

5. An optical adaptor according to claim 4, wherein T/R_{C} is approximately equal to 4.5.

6. An optical adaptor according to claim 1, wherein said primary meniscus lens is a compound lens.

7. An optical adaptor according to claim 1, wherein said primary meniscus lens is a doublet lens.

8. An optical adaptor according to claim 1, wherein said secondary lens unit comprises a secondary meniscus lens.

9. An optical adaptor according to claim 8, wherein said secondary meniscus lens is configured such that its concave surface faces said primary lens unit and has a smaller radius of curvature than its convex surface.

10. An optical adaptor according to claim 1, wherein said secondary lens unit comprises a compound lens.

11. An optical adaptor according to claim 1, wherein said secondary lens unit comprises a doublet lens.

12. An optical adaptor according to claim 1, wherein the thickness of said primary lens unit is substantially greater than the thickness of said secondary lens unit.

13. An optical adaptor according to claim 12, wherein the thickness of said secondary lens unit is approximately 40% of the thickness of said primary lens unit.

14. An optical arrangement comprising an optical adaptor according to claims 1, provided in combination with said optical imaging system.

15. An optical arrangement according to claim 14, wherein said optical imaging system is configured to have an f-number of at least 4.

16. A sample viewing device comprising an optical arrangement according to claim 15, the viewing device further comprising means to support a microplate having a plurality of wells in a viewing position in which at least part of the microplate may be imaged by said imaging system, said optical adaptor being selectively moveable between a first position in which it lies within the optical path between the microplate and the imaging system and a second position in which it is removed from said optical path, wherein said optical adaptor is arranged when in said flat position to modify the field curvature of the imaging system so as to produce a substantially flat focused image of a curved surface of a said well.
